(19) United States
(12) Patent Application Publication
(10) Pub. No.: US 2026/0196222 A1
(43) Pub. Date: Jul. 9, 2026

(54) SYSTEM AND METHODS FOR SCALABLE AI-DRIVEN MALFEASANCE DETECTION WITH INTEGRATED FEEDBACK

(71) Applicant: BANK OF AMERICA CORPORATION, Charlotte, NC (US)

(72) Inventor: Frederick Borcherdt, III, Newark, DE (US)

(73) Assignee: BANK OF AMERICA CORPORATION, Charlotte, NC (US)

(21) Appl. No.: 19/013,489

(22) Filed: Jan. 8, 2025

(51) Int. Cl. G10L 15/26; G10L 15/06

(52) U.S. Cl. CPC G10L 15/26; G10L 15/063

(57) ABSTRACT

Systems, computer program products, and methods are described herein for scalable AI-driven malfeasance detection with integrated feedback. The present disclosure includes receiving a data stream having audio input data associated with a digital signal transmission, where the audio input data may include speech data, generating, using natural language processing of a generative AI model, a document having text data based on the speech data, determining, via a machine learning model, an account identifier based on the text data, and a malfeasance category corresponding to the account identifier, determining, via the machine learning model, resource transfer metrics, and determining, via the machine learning model, a malfeasance rating, where the malfeasance rating may be categorized in a malfeasance rating category based on comparing the malfeasance rating to a predetermined threshold.

### TECHNOLOGICAL FIELD

Example implementations of the present disclosure relate to a system and method for scalable AI-driven malfeasance detection with integrated feedback.

### BACKGROUND

Currently, entities face numerous challenges in safeguarding their systems against malfeasance, particularly as malfeasance attack vectors continually evolve and diversify. A primary concern for these entities is managing cyber vulnerabilities across a broad range of devices within extensive network operations. With systems in place to detect malfeasance and prevent breaches, any gaps or outdated defenses expose the entities to possibility of unauthorized access and potential losses. While regulations mandate that entities address identified vulnerabilities on a timely basis, determining the existence of such vulnerabilities proves to be timely and cost ineffective, oftentimes requiring evaluating collateral damage after malfeasance has already occurred, or inadvertently allowing novel malfeasance techniques go undetected due to entity focus on outdated tactics. As such, there is a need for systems and method for scalable AI-driven malfeasance detection with integrated feedback.

### BRIEF SUMMARY

Systems, methods, and computer program products are provided for scalable AI-driven malfeasance detection with integrated feedback.

In one aspect, a system for scalable AI-driven malfeasance detection with integrated feedback is presented. The system may include a processing device, and a non-transitory storage device containing instructions, when executed by the processing device, the instructions cause the processing device to perform the steps of receiving a data stream having audio input data associated with a digital signal transmission, where the audio input data may include speech data, transmitting the speech data to a generative AI model, generating, using natural language processing of the generative AI model, a document having text data based on the speech data, determining, via a machine learning model, an account identifier based on the text data being provided to the machine learning model, and a malfeasance category corresponding to the account identifier, determining, via the machine learning model based on the text data being provided to the machine learning model, resource transfer metrics having a location of the digital signal transmission and a resource transfer volume, and determining, via the machine learning model, a malfeasance rating, where the malfeasance rating may be categorized in a malfeasance rating category as high, medium, or low based on comparing the malfeasance rating to a predetermined threshold.

In some implementations, the instructions may further cause the processing device to perform the steps of retrieving account data having resource transfer occurrence patterns corresponding to the account identifier, retrieving historical malfeasance incident data from a malfeasance incident database, retrieving adversarial action framework data from an adversarial action framework database, and training the machine learning model to determine the malfeasance rating of the text data using the account data, the historical malfeasance incident data, and the adversarial action framework data.

In some implementations, generating the text data occurs in real time upon receiving the audio input data in a stream of audio input data, and determining the malfeasance rating via the machine learning model occurs in parallel with generating the text data.

In some implementations, the instructions may further cause the processing device to perform the steps of transmitting, upon a condition where the malfeasance rating may be categorized in a predetermined category, an alert signal.

In some implementations, the alert signal may be transmitted to an endpoint device, and the alert signal may cause the endpoint device to display at least one of: (i) the account identifier, (ii) the malfeasance rating, (iii) the malfeasance rating category, and (iv) the resource transfer metrics.

In some implementations, the alert signal may include instructions to further cause the processing device to perform the steps of reversing any resource transfer associated with the account identifier occurring during the data stream, and terminating the data stream.

In some implementations, the adversarial action framework database may include an application programming interface (API) for access to a matrix having known adversary tactics and sequences of the adversary tactics.

In another aspect, a computer program product for scalable AI-driven malfeasance detection with integrated feedback is presented. The computer program product may have a non-transitory computer-readable medium having code causing an apparatus to receive a data stream having audio input data associated with a digital signal transmission, where the audio input data may include speech data, transmitting the speech data to a generative AI model, generate, using natural language processing of the generative AI model, a document having text data based on the speech data, determine, via a machine learning model, an account identifier based on the text data being provided to the machine learning model, and a malfeasance category corresponding to the account identifier, determine, via the machine learning model based on the text data being provided to the machine learning model, resource transfer metrics having a location of the digital signal transmission and a resource transfer volume, and determine, via the machine learning model, a malfeasance rating, where the malfeasance rating may be categorized in a malfeasance rating category as high, medium, or low based on comparing the malfeasance rating to a predetermined threshold.

In some implementations, the code may further cause the apparatus to retrieve account data having resource transfer occurrence patterns corresponding to the account identifier, retrieve historical malfeasance incident data from a malfeasance incident database, retrieve adversarial action framework data from an adversarial action framework database, and train the machine learning model to determine the malfeasance rating of the text data using the account data, the historical malfeasance incident data, and the adversarial action framework data.

In some implementations, generating the text data occurs in real time upon receiving the audio input data in a stream of audio input data, and determining the malfeasance rating via the machine learning model occurs in parallel with generating the text data.

In some implementations, the code may further cause the apparatus to transmit, upon a condition where the malfeasance rating may be categorized in a predetermined category, an alert signal.

In some implementations, the alert signal may be transmitted to an endpoint device, and the alert signal may cause the endpoint device to display at least one of: (i) the account identifier, (ii) the malfeasance rating, (iii) the malfeasance rating category, and (iv) the resource transfer metrics.

In some implementations, the alert signal may include code further causing the apparatus to reverse any resource transfer associated with the account identifier occurring during the data stream, and terminate the data stream.

In some implementations, the adversarial action framework database may include an application programming interface (API) for access to a matrix having known adversary tactics and sequences of the adversary tactics.

In yet another aspect, a method for scalable AI-driven malfeasance detection with integrated feedback is presented. The method may include receiving a data stream having audio input data associated with a digital signal transmission, where the audio input data may include speech data, transmitting the speech data to a generative AI model, generating, using natural language processing of the generative AI model, a document having text data based on the speech data, determining, via a machine learning model, an account identifier based on the text data being provided to the machine learning model, and a malfeasance category corresponding to the account identifier, determining, via the machine learning model based on the text data being provided to the machine learning model, resource transfer metrics having a location of the digital signal transmission and a resource transfer volume, and determining, via the machine learning model, a malfeasance rating, where the malfeasance rating may be categorized in a malfeasance rating category as high, medium, or low based on comparing the malfeasance rating to a predetermined threshold.

In some implementations, the method may further include retrieving account data having resource transfer occurrence patterns corresponding to the account identifier, retrieving historical malfeasance incident data from a malfeasance incident database, retrieving adversarial action framework data from an adversarial action framework database, and training the machine learning model to determine the malfeasance rating of the text data using the account data, the historical malfeasance incident data, and the adversarial action framework data.

In some implementations, generating the text data occurs in real time upon receiving the audio input data in a stream of audio input data, and determining the malfeasance rating via the machine learning model occurs in parallel with generating the text data.

In some implementations, the method may further include transmitting, upon a condition where the malfeasance rating may be categorized in a predetermined category, an alert signal.

In some implementations, the alert signal may be transmitted to an endpoint device, and the alert signal causes the endpoint device to display at least one of: (i) the account identifier, (ii) the malfeasance rating, (iii) the malfeasance rating category, and (iv) the resource transfer metrics.

In some implementations, the adversarial action framework database may include an application programming interface (API) for access to a matrix having known adversary tactics and sequences of the adversary tactics.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for scalable AI-driven malfeasance detection with integrated feedback, in accordance with an implementation of the disclosure;

FIG. 2 illustrates an exemplary machine learning model subsystem architecture, in accordance with an implementation of the disclosure;

FIG. 3 illustrates an exemplary generative AI model subsystem, in accordance with an implementation of the disclosure;

FIGS. 4A-4C illustrate a process flow for scalable AI-driven malfeasance detection with integrated feedback, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. In some implementations, “engine” may be used interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative AI model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

Current malfeasance detection systems in entity environments are hindered by their inability to identify malfeasant activities in real-time without consuming extensive computational resources. The issue intensifies when dealing with a large inventory of devices, each requiring constant vulnerability assessment and mitigation. Existing protocols necessitate frequent cross-referencing with vulnerability disclosures, such as those published by MITRE, and applying necessary patches or updates to each device, which may be a manual process. This process is resource-intensive, prone to delays, and increases exposure to potential malfeasance during periods when vulnerabilities remain unaddressed. These inefficiencies hinder the entity's ability to maintain a secure network perimeter, thereby impeding timely and effective malfeasance detection.

Existing solutions primarily focus on periodic vulnerability assessments and reactive updates to operating systems or software as vulnerabilities are disclosed. Entities often employ automated inventory crawlers that identify devices with flagged vulnerabilities, prompting manual or semi-automated interventions such as system patches, OS upgrades, or device deactivation. However, these approaches are inadequate for real-time malfeasance prevention. They are resource-intensive and introduce latency in detecting and responding to emerging threats. The mandated remediation timelines do not align well with the immediacy required for real-time malfeasance detection, leaving networks susceptible to malfeasance.

Addressing these challenges requires the establishment of a system and method for scalable AI-driven malfeasance detection with integrated feedback, which provides for the implementation of a specialized machine learning model, that has been trained using an adversarial action framework database, to identify a malfeasance in real-time, with weight given to particularities derived from a data stream produced during an interaction between an entity and a user.

To do so, a machine learning model may be trained in a specific manner. Account data may be retrieved, where the account data may be corresponding to a particular user identified by an account identifier. This account data may include resource transfer occurrence patterns, such as time, place, and so forth (as will be described herein). In addition to the account data, historical malfeasance incident data may be retrieved. Additionally, or alternatively, adversarial action framework data from an adversarial action framework database may be retrieved, where the adversarial action framework database provides access to a matrix having known adversary tactics and sequences of the adversary tactics. Using one or more of the foregoing data sources, the machine learning model may then be trained to determine a malfeasance rating of a stream of text data, such that entities may prioritize malfeasant activities.

A data stream of audio input data associated with a digital signal transmission may be received by the system. This audio input data may include speech data, which is then transmitted to a generative AI model tasked with generating a text data document (e.g., speech-to-text). The generation of text data may occur in real-time from a stream of audio input data. Using this text, the machine learning model discussed previously may determine an account identifier, a malfeasance category corresponding to the account identifier, a location of the digital signal transmission, a resource transfer volume, and/or a malfeasance rating. The determining of the malfeasance rating may occur in parallel (i.e., also in real-time) while receiving the stream of audio input data. If the malfeasance rating falls within a predetermined category, an alert signal may be generated and transmitted to an endpoint device, which may cause the input device to display (i.e., identify) the account identifier, malfeasance rating, malfeasance rating category, resource transfer metrics, and/or the like. Depending on the implementation and values of the foregoing account identifier, malfeasance rating, malfeasance rating category, resource transfer metrics, and/or the like, a resource transfer associated with the account identifier may be reversed, and/or the data stream of audio input data may be terminated.

What is more, the present disclosure provides a technical solution to a technical problem. As described herein, the technical problem includes the inability of current malfeasance detection systems in entities to identify malfeasant activities in real-time without overwhelming computational resources, compounded by delays in addressing device vulnerabilities as they are disclosed. The present disclosure embraces an improvement over existing solutions by allowing for malfeasance detection (i) with fewer steps to achieve the solution (e.g., proactively receiving a data stream to analyze for malfeasance as opposed to reactive analysis post-receipt of said data stream, which would require both the analysis step and additional steps for storing, retrieving, or the like), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., by continuously training a machine learning model based on remedial action feedback, in order to improve the accuracy of the factors determined by the machine learning model from the data stream, including malfeasance rating, account identification, resource transfer metrics, or the like), (iii) removing manual input and waste from the implementation of the solution, thus improving speed and efficiency of the process and conserving network resources (e.g., eliminating the requirement to manually compare malfeasant activities against adversarial action frameworks and/or manually implementing remediations), (iv) determining an optimal amount of resources that need to be used to implement the solution, thus reducing network traffic and load on existing network resources (e.g., by categorizing malfeasance into categories based on the malfeasance rating, entities can focus on only certain categories of malfeasance that is most efficient to eliminate). In other words, the solution may bypass a series of steps previously implemented, thus further conserving network resources. Furthermore, the technical solution described herein uses a rigorous, computerized process to perform specific tasks and/or activities that were not previously performed.

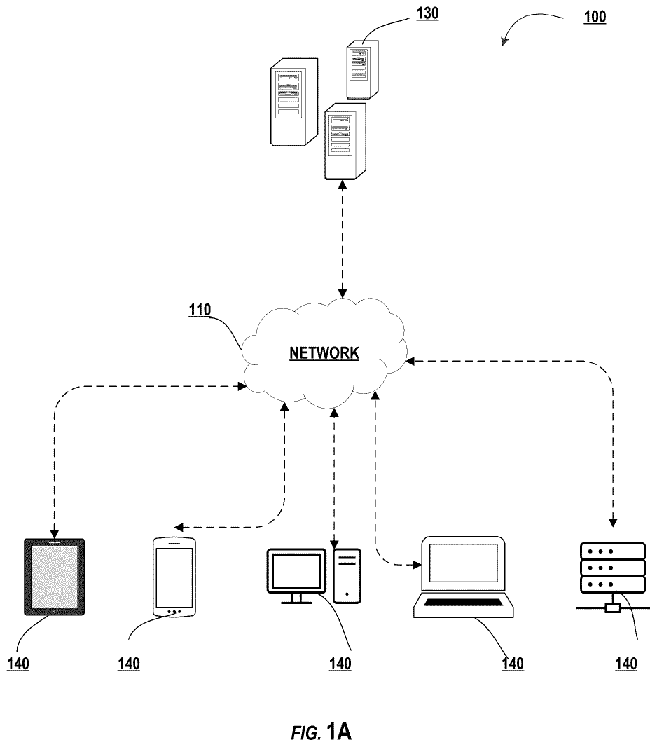

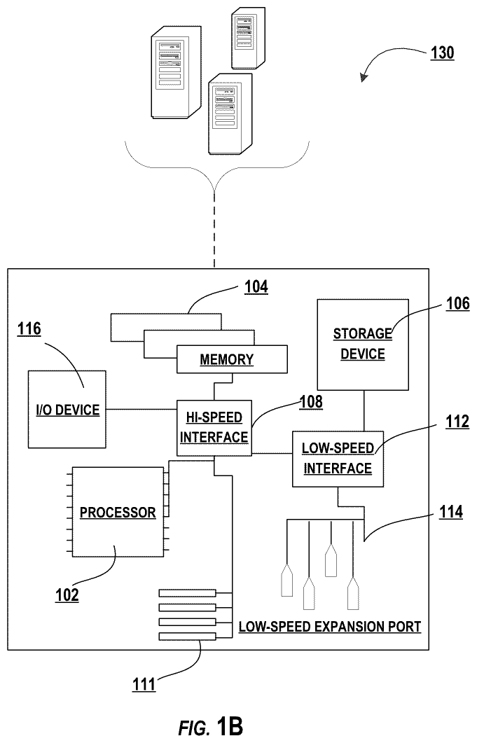

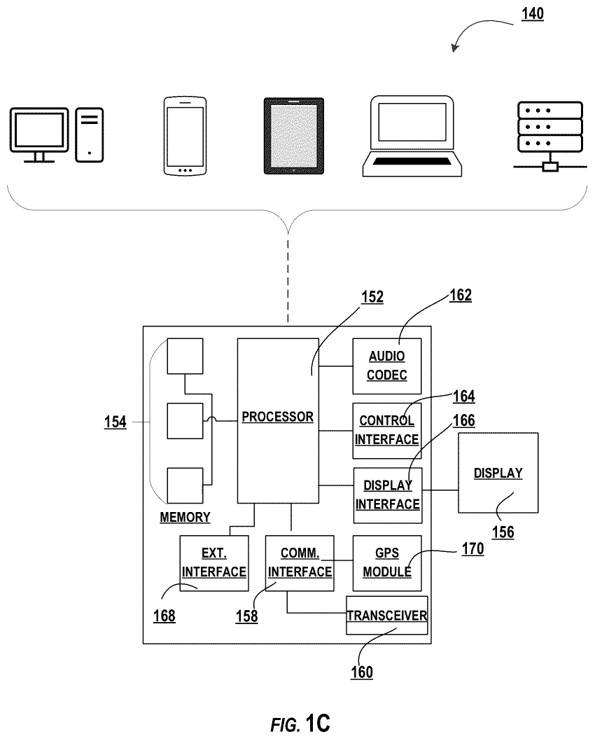

FIGS. 1A-1C illustrate technical components of an exemplary distributed computing environment 100 for scalable AI-driven malfeasance detection with integrated feedback, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

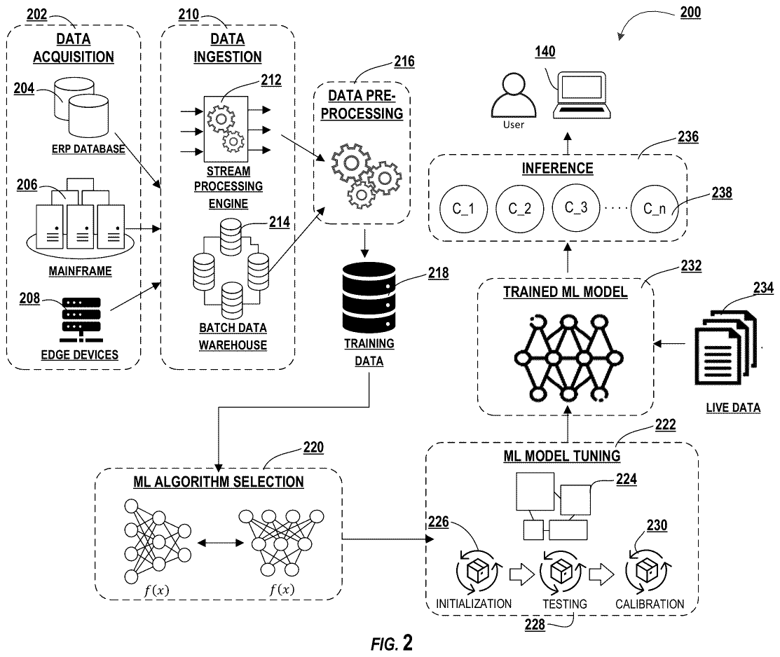

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

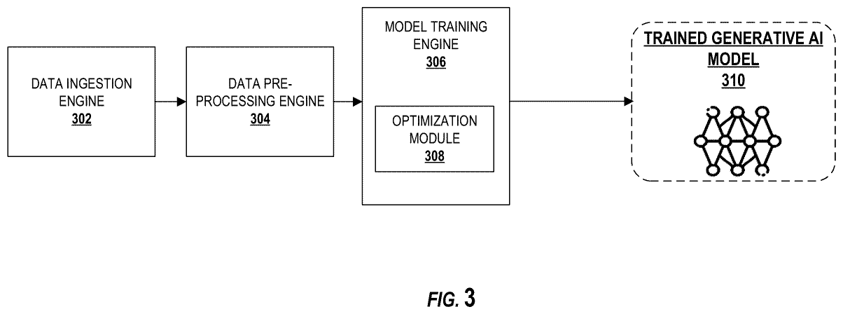

FIG. 3 illustrates an exemplary generative AI subsystem 300, in accordance with an implementation of the disclosure. The generative AI subsystem 300 may include a data ingestion engine 302, a data pre-processing engine 304, and a model training engine 306. It should be understood that the generative AI subsystem 300 is merely an example, and other implementations may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the disclosure.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some implementations, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some implementations, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some implementations, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models 310 using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some implementations, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In implementations involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In implementations involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models 310, the model training engine 306, which may include an optimization module 308, may implement various optimization techniques to improve model performance and efficiency. The optimization module 308 may be responsible for continuously adjusting the internal parameters of the model using feedback from relevant loss functions tailored to the application (e.g., text, image, audio, or video generation). Techniques such as gradient clipping, learning rate scheduling, and mixed-precision training may be applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some implementations, the model training engine 306 may implement early stopping mechanisms to prevent overfitting. Early stopping monitors the generative AI model performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This may be particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model 310 in a persistent storage location for future use. In specific implementations, metadata such as the number of epochs, the final loss values, and values of learned parameters may be logged for model versioning and/or retraining at a later stage. In some implementations, the model training engine 306 may also implement transfer learning, where a pre-trained model may be fine-tuned on a smaller, domain-specific dataset. This may reduce the amount of time and data required to train a new model, especially in cases where the available data may be limited or highly specialized. The model training engine 306 may adjust the parameters of the pre-trained model to better align with the new dataset, while preserving the learned features from the original training.

In implementations involving LLMs, new output may be generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which influence the randomness of the token sampling, enabling the generation of diverse or deterministic responses.

In image generation models, such as those using ViTs or GANs, new output may be generated by sampling from the learned distribution in the model's latent space. For GANs, the generator network creates an image by transforming random noise vectors into structured image outputs through a series of layers that learn visual features like shapes, textures, and colors. The generated image may be then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some implementations, generative AI models 310 may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the implementation of the generative AI subsystem 300 illustrated in FIG. 3 is exemplary and that other implementations may vary. The generative AI subsystem 300, as well as its constituent elements, may vary, and modifications or alternative configurations may be implemented without departing from the broader scope of the disclosure. For instance, different machine learning algorithms, data sources, optimization techniques, or training methodologies may be employed depending on system requirements, application domain, and available computational resources. Furthermore, features and functionalities described in one implementation may be combined with those of another implementation as needed, and vice versa.

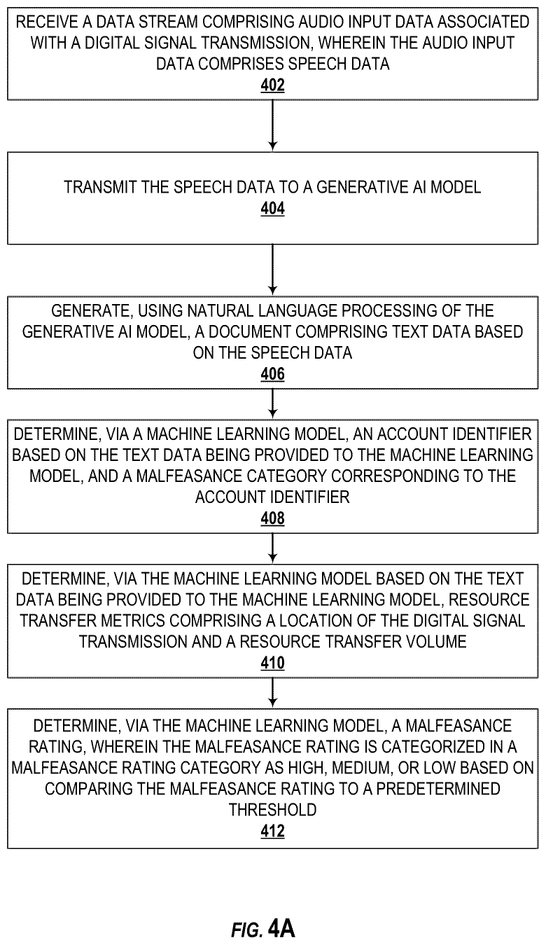

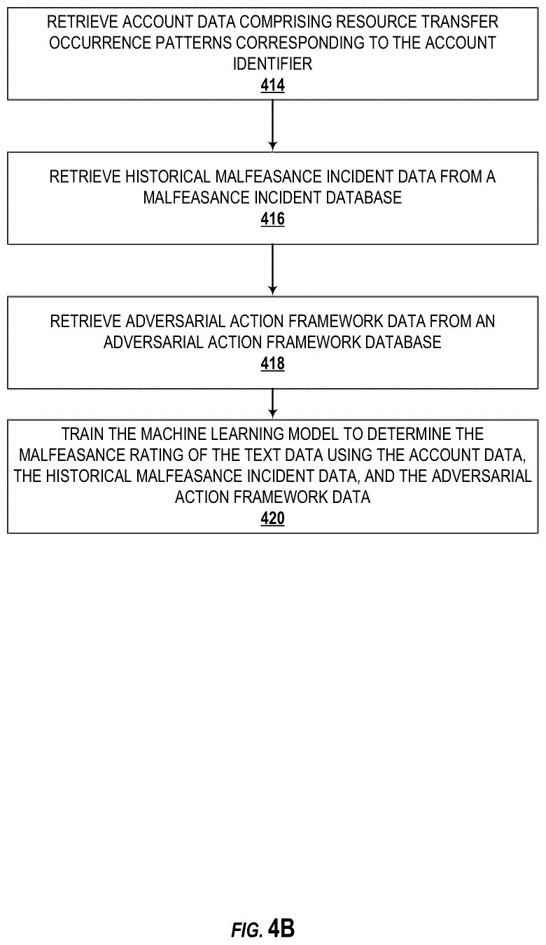

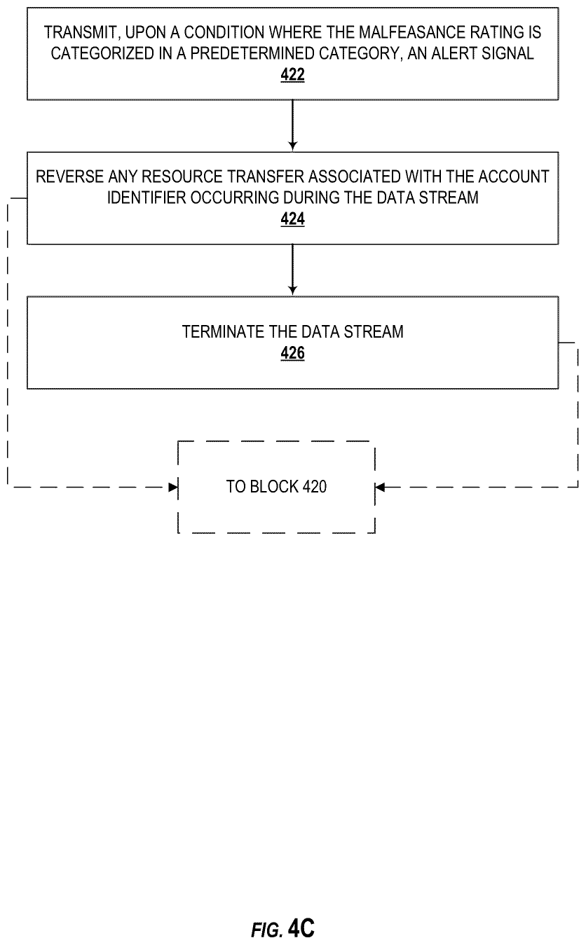

FIGS. 4A-4C illustrate a process flow for scalable AI-driven malfeasance detection with integrated feedback, in accordance with an implementation of the disclosure. At block 402 of FIG. 4A, the system 130 may receive a data stream. The system 130 may receive a data stream initiated by and/or originating from a first user and transmitted to the system 130 via at least one channel. A user, which may be a customer, client, or other inquirer, may initiate an interaction with the entity. This initiation of an interaction may be the start of a phone call, a text chat message to a chatbot or multi-channel cognitive interaction platform, a connection to a video chat, a voice prompt to a multi-channel cognitive interaction platform, or the like.

After the initiation of the interaction, data stream may flow to the system 130 via at least one channel. In some implementations, examples of channels include, but are not limited to a multi-channel cognitive resource platform, a web interface, an email interface, a mobile phone application, a telephone communication, or the like. Indeed, many such channels are contemplated, any of which is suitable for the present disclosure, provided that the channel results in the data stream being provided to the system 130.

In some implementations, the data stream may have audio input data associated with a digital signal transmission, where the audio input data may include speech data. Speech data in the audio input data may include time-sequential digital signals representing variations in air pressure captured by a microphone, which correspond to vocal sounds. The audio input data may be sampled at a predetermined frequency, typically in kilohertz, and quantized into discrete amplitude levels to generate a series of numerical values. These samples may undergo preprocessing stages, such as filtering to remove noise or normalizing amplitudes. The speech data may include temporal features, like pitch and tone modulation, and spectral features, such as formants. To analyze or utilize the speech data, feature extraction methods like Mel-frequency cepstral coefficients (MFCCs) or linear predictive coding (LPC) may be applied to capture aspects of the speech data for use in subsequent processing, such as that which is described in block 406.

Next, at block 404, the speech data may be transmitted to a generative AI model 310 trained to process speech data. In particular, the generative AI model 310 described herein may be trained to perform voice transcription (speech-to-text) using natural language processing (NLP). To be trained to do so, waveforms from audio signals may be transformed into representations such as spectrograms or the like, to allow the generative AI model 310 to distinguish phonetic components of spoken language. During training, the generative AI model 310 may learn to map audio signals to phonetic patterns and words to capture linguistic nuances like accents, dialects, and speaking speeds. The generative AI model 310 may engage in iterative learning and fine-tuning with labeled datasets to minimize transcription errors.

Additionally, or alternatively, the generative AI model 310 may be trained to perform speaker identification and verification to transcribe, from the data stream, only one user's interaction with the entity. As such, if multiple speakers are identified, transcribing the speech data may result in more than one transcription, with each identified speaker having a corresponding transcription (i.e., text data). To do so, the generative AI model 310 may identify vocal features unique to each individual, such as pitch, tone, speech patterns, or the like. The training process to accomplish this may use labeled audio samples from a variety of speakers, where MFCCs are extracted to capture the nuances of each voice. Deep learning techniques such as convolutional neural networks or recurrent neural networks may be implemented for feature extraction and classification. During training, the generative AI model 310 may learn to differentiate and recognize speaker-specific attributes.

Additionally, or alternatively, the generative AI model 310 may be trained to perform sentiment analysis (i.e., emotion detection) within voice data. To do so, the generative AI model 310 may be trained on datasets that pair vocal expressions with labeled emotional states or sentiment classifications. Features such as pitch, tone, rhythm, loudness, or the like, may be analyzed to determine emotion. Recurrent architectures, such as Long Short-Term Memory (LSTM) networks, may be implemented for emotion recognition due to their capacity to understand temporal dependencies. During training, the generative AI model 310 may refine how particular acoustic signatures correlate with different emotional expressions.

Continuing at block 406, the system 130 may generate a document or file having text data based on the speech data. To do so, the natural language processing of the generative AI model 310 may be leveraged such as to convert the speech to text data. The text data may be included in any number of formats, including, but not limited to, plain text, XML, JSON, HTML, CSV, .DOCX, .TXT, or proprietary data structures.

In some implementations, generating the text data occurs in real time upon receiving the audio input data in a stream of audio input data. This may occur in parallel with the determining of the malfeasance rating via the machine learning model 232 (based on the text data), which is described with respect to block 412 herein. In this way, any or all of the remaining steps described subsequent to block 406 may be performed in an ongoing basis, and the system 130 does not need to wait until a data stream has ended to determine the malfeasance rating, and potential malfeasance is thwarted rapidly.

At block 408, the system 130 may determine an account identifier (e.g., an account number). To do so, a machine learning model 232 may be used to analyze the text data upon being provided with the text data. Based on this text data, the system 130 may determine an identity of the user engaging with the entity and thereby determine an account identifier associated with said user. Additionally, or alternatively, the account identifier may be determined based on communication data extracted from the interaction.

For example, the text data may include a full name, address, date of birth, phone number, email address, government identifier, billing information, an account identifier, a partial account identifier, a password, or the like. The machine learning model 232 may parse the text data and determine if one or more of the foregoing elements are in the text data, and if so, the value (e.g., the text associated with) of the elements for use in determining the corresponding output identifier.

Additionally, or alternatively to the text data, the system 130 may receive communication data inherent to the data stream, including a phone number used for communicating with the entity, an IP address, a geolocation, an IMEI numeric identifier and/or a MAC address of the hardware used to communicate with the entity, an account number or application login information associated with an application used to communicate with the entity (e.g., a mobile or web application), internet cookies, or the like.

The machine learning model 232 may analyze the foregoing identifiable information received by the system 130 (e.g., the text data and/or the communication data) and determine an account identifier of the user. The machine learning model 232 may be trained using a dataset from an account database containing account identifiers, text data, communication data, or the like where parameters are iteratively adjusted to minimize the error between its predictions and the actual outcomes. During training, optimization techniques may be utilized, as described with respect to FIG. 2. Once trained, the output may be characterized by an identity or an account identifier corresponding to the identity.

In some implementations, the machine learning model 232 may operate as a direct lookup table. In cases where the input text data and/or communication data values exactly match entries in the original dataset in the account database, the machine learning model 232 would bypass prediction algorithms and retrieve the corresponding account identifier value directly. This lookup mechanism may involve establishing a dictionary or hash map where text data and/or communication data serve as a key that is mapped to a pre-defined account identifier output.

In some implementations, once an account identifier has been determined, verification tasks may be performed such as confirming a speaker's identity using similarity scoring, where the machine learning model 232 may calculate the probability of a match (e.g., a verification that the user is associated with the account identifier) by comparing the voice sample in the voice data against a stored template or voiceprint associated with the account identifier in the account database. Should the machine learning model 232 determine that the probability is above a predetermined threshold, a positive match may be assumed, and the process may continue as described hereinafter. If the probability is below a predetermined threshold, the process may cease. After the process ceases, the machine learning model 232 may be provided with this mismatch information (i.e., provided with the determined account identifier and the text data and/or the communication data) to engage in additional machine learning processes, such as retraining with updated datasets, adjusting feature weights, or refining algorithms, to enhance its predictive accuracy continuously.

It shall be appreciated that entities benefit from maintaining malfeasance records of users, such as to implement a heightened standard scrutiny regarding activity of users who have previously engaged in questionable (e.g., malfeasant) conduct. To do so, account identifiers may be stored in the account database alongside a malfeasance category. The malfeasance category of an account identifier may serve as an agglomeration of past activity, where the malfeasance category of a given account identifier is selected from two or more categories based on the number of times (or a percentage of times) that a data stream associated with the account identifier has been provided with a malfeasance rating above a predetermined threshold. While the determination of the malfeasance rating is described in detail herein, it is important to understand the relationship between the malfeasance rating(s) of an account identifier and the malfeasance category that is a result thereof.

For example, a predetermined threshold for malfeasance ratings for a given data stream may be set at 5, where malfeasance ratings above 5 are “high” (i.e., a high likelihood of being malfeasant activity), while malfeasance ratings below 5 are “low” (i.e., a low likelihood of being malfeasant activity). Regarding malfeasance categories, a predetermined number may be set such that if, for example, 2 data streams of a given account identifier are “high” according to the malfeasance rating, the account identifier is given a “high” malfeasance category. In this example, if Account X has interacted with the entity 3 times (i.e., producing 3 data streams) and only one of the data streams was determined to be “high” (i.e., having a malfeasance rating above 5), the malfeasance category may be “low” (i.e., below the predetermine number of 2). However, if upon Account X interacting with the entity a fourth time, the fourth data stream is determined to be “high” (i.e., having a malfeasance rating above 5), then 2 of Account X's 4 data streams would be considered “high”, and the malfeasance category associated with Account X would change from “low” to “high.”

In some implementations, the malfeasance category corresponding to the account identifier may be retrieved from the account database and used in subsequent malfeasance rating analyses for the account identifier. In this way, data streams associated with “high” account identifiers are provided more scrutiny by it being “easier” for such data streams associated with the account identifier to achieve a “high” malfeasance rating.

Additionally, or alternatively, sentiment analysis (i.e., emotion detection) may be performed on the data stream by the machine learning model 232. It shall be appreciated that malfeasant actors may engage in coercive tactics or use language and syntax not typical of a legitimate actor. As such, the machine learning model 232 may examine the data stream (i.e., the text data from the data stream) to detect emotional cues indicative of perturbation or coercion. The machine learning model 232 may analyze language components like word choice, syntax, and tone intensity, to identify signs of frustration, anger, anxiety, or undue influence. The machine learning model 232 may calculate a sentiment score across one or more emotional and coercive dimensions and discern, based on comparing this sentiment score to a predetermined threshold, if the overall tone suggests a perturbed or pressured state. Based on comparison to the predetermined threshold, sentiment scores above or below a predetermined threshold may increase or decrease the malfeasance rating by a predetermined amount. Additionally, or alternatively, sentiment scores above or below a predetermined threshold may alter the malfeasance category from “low” to “high” or vice versa.

Turning briefly to FIG. 4B, the machine learning model 232 may be trained in a specialized manner such that a malfeasance rating is able to be determined based on account data of a given account identifier, and, in some implementations, also the malfeasance category of the account identifier and/or the sentiment analysis determined for the data stream. As previously described, account data may be corresponding to a particular user identified by an account identifier. This account data may include resource transfer occurrence patterns, such as time, place, and so forth.

In some implementations, each account identifier may be associated with an exclusive machine learning model 232 individually trained on account-specific data, such that inputs associated with account identifiers are processed by the corresponding model to produce the malfeasance rating.

In other implementations, a single, centralized machine learning model 232 may be trained to consider an account identifier when generating outputs. In such configurations, the machine learning model 232 processes user inputs in combination with the account identifier to ensure that the generated output reflects the unique attributes, preferences, or historical data of the specific user identified by the account identifier, while still operating as a single model.

Thus, to prepare for training of the machine learning model 232, at block 414, the system 130 may retrieve account data having resource transfer occurrence patterns and/or data stream occurrence patterns corresponding to an account identifier. It shall be appreciated that voluminous and/or rapidly executed resource transfers may be signs of malicious activity. Similarly, voluminous and/or rapidly executed data streams may also be a sign of malicious activity. For example, account data of an account identifier may contain data regarding resource transfers to and from an account of a user associated with the account identifier. Thus, in some implementations, the system 130 may use resource transfer occurrence patterns and/or data stream occurrence patterns associated with the account identifier to help infer, via the machine learning model 232, a malfeasance rating for an incoming data stream. The frequency of resource transfers or data streams between the user, as previously identified, and the entity, over a given timespan may be determined and used as training data to quantify the malfeasance of an account identifier. Resource transfer occurrence patterns and/or data stream occurrence patterns may be calculated as a function of number of resource transfers (and/or data streams), per hour, per day, per week, and so forth, particular days of the week, days of the month, months of the year, and so forth where the user engages in resource transfers, particular time of day that the user engages in resource transfers, or the like. Similarly, the volume of resource transfers (i.e., the fiscal amount of the resource transfers) or data streams (i.e., the duration of the data streams) between the user, as previously identified, and the entity, over a given timespan may be determined and used as training data to quantify the malfeasance of an account identifier.

The machine learning model 232 may be trained using a dataset containing (1) the account identifier, (2) the aforementioned record data containing resource transfer occurrence patterns (volume and/or frequency) and/or data stream occurrence patterns (volume and/or frequency) (3) sample text data, either from past interactions between the entity and the user associated with the account identifier, or sample text data for training purposes, and/or (4) example malfeasance ratings. In some implementations, the record data containing resource transfer occurrence patterns (volume and/or frequency) and/or data stream occurrence patterns (volume and/or frequency) may also be sample record data not explicitly associated with the account identifier, which allows for baseline training of the model to be improved respective to each account identifier as a feedback training paradigm is implemented during/after future interactions between user(s) and the entity.

In some implementations, the malfeasance category currently assigned to the account identifier may also be used as training data, such that account identifiers having higher malfeasance categories may result in the output of a higher (or lower) malfeasance rating.

At block 416, to train the machine learning model 232, the system 130 may also retrieve historical malfeasance incident data from a malfeasance incident database. The malfeasance incident database may contain records detailing specific instances of malfeasance, each associated with an account identifier. The data entries may include the nature of the incident, date and time of occurrence, severity or impact rating, and any corrective actions taken. Historical malfeasance data related to a particular account identifier may be retrieved by querying the database using the account identifier.

Next, at block 418, to train the machine learning model 232, the system 130 may also retrieve adversarial action framework data from an adversarial action framework database. As used herein, an “adversarial action framework database” may refer to a framework that contains a comprehensive knowledge base detailing the tactics, techniques, and procedures (“TTPs”) used by adversaries in cyber operations. The adversarial action framework database organizes these TTPs into matrices to illustrate the various stages of an attack lifecycle, including initial access, execution, persistence, privilege escalation, and exfiltration. This adversarial action framework database enables security professionals to understand, detect, and defend against cyber intrusions by providing a detailed view of adversarial behaviors. The adversarial action framework database may also include a common vulnerabilities and exposures list of publicly known cybersecurity vulnerabilities, where each entry is coupled with detailed descriptions and severity assessments. The adversarial action framework database may also include a common weakness enumeration list, which classifies and categorizes software weaknesses and focuses on the root causes of vulnerabilities such as input validation failures or authentication issues. Collectively, the data in the adversarial framework database, including any common vulnerabilities and exposures, as well as any common weakness enumeration, are referred to herein as “adversarial action framework data.” In some implementations, the adversarial action framework database may include an application programming interface (API) for access to this adversarial action framework data.

The machine learning model 232 may be trained to assess the data stream (e.g., the text data) by mapping the text data against adversarial action framework data to identify patterns that may signal adversarial tactics. For example, if a user attempts unauthorized access to privileged files or executes uncharacteristic commands, these actions can be aligned with adversarial action framework data techniques, and/or if identified activities may be opportunistic of any known vulnerabilities in the software, hardware, or protocols.

Using the foregoing information, at block 420, the machine learning model 232 may be trained to determine the malfeasance rating of the text data using the account data, the historical malfeasance incident data, and/or the adversarial action framework data. In other words, once trained, the machine learning model 232, having an input of the account identifier (or the machine learning model 232 being specific to the account identifier) and an input of the text data of a data stream, is able to output a malfeasance rating that is specific to the data stream (e.g., by using the incoming text data), specific to the account identifier (e.g., by providing malfeasance weight to interaction volume and frequency specific to the user as well as historical malfeasance incident data), as well as specific to current tactics (e.g., by providing adversarial action framework data).

Returning back to FIG. 4A, at block 410, in some implementations, the system 130 may determine resource transfer metrics of the data stream. Specifically, the system 130 may determine resource transfer metrics of (i) a location of the digital signal transmission and/or (ii) a resource transfer volume. For the instant data stream, a user may be requesting a resource transfer volume (e.g., currency amount) in excess of a predetermined threshold set for a given account identifier. Thus, heightened scrutiny into any potential malfeasance may be warranted. Similarly, location of the digital signal transmission may be indicative of a foreign malfeasant actor in a location not associated with the account identifier in the past.

Such determinations may be made by a machine learning model 232, either the same machine learning model 232 previously described, or an entirely separate second machine learning model 232. This machine learning model 232 may be provided with the text data of the data stream and/or the communication data of the data stream, and infer, based on the contents of the text data and/or communication data, the resource transfer volume and/or a geolocation of the digital signal transmission.

In some implementations, the inferences of block 410 may be provided to the machine learning model 232 described above with respect to FIG. 4B. In such implementations the resource transfer volume and/or a geolocation of the digital signal transmission may be used as input(s) to said machine learning model 232, and said machine learning model 232 may have been further trained to receive the input(s) and use any discrepancies between (i) the geolocation and the known geolocations associated with the account identifier, and/or (ii) the resource transfer volume and a predetermined threshold volume for the account identifier, to influence the output malfeasance rating.

Continuing at block 412, the machine learning model 232 of the system 130 may determine a malfeasance rating of the text data, as discussed with respect to training the machine learning model 232 at FIG. 4B, by receiving the text data and the account identifier. In some implementations, the malfeasance rating may be numeric. In other implementations, the malfeasance rating may be numeric and subsequently categorized, based on predetermined thresholds of the numeric rating, into a malfeasance rating category as high, medium, or low based on comparing the malfeasance rating to the predetermined threshold.

In some implementations, the system 130 may repeat the determining of the malfeasance rating at a predetermined interval during the receiving of the stream of the data stream. Stated differently, the system 130 may repeat one or more of the actions of block 412 in an ongoing manner according to predetermined time intervals, for example, every 5 seconds, 10 seconds, 30 seconds, 1 minute, 2 minutes, 3 minutes, 5 minutes, 10 minutes, 30 minutes, or any other length of time. In doing so, the system 130 may effectively re-affirm or recalculate the malfeasance rating on a continuous basis and thereby create a “zero-trust” framework, as the beginning of a given data stream, if evaluated in real-time, may be benign, while later portions of the data stream could indicate malicious activity.

Turning now to FIG. 4C, at block 422, in some implementations, the system 130 may transmit an alert signal to an endpoint device upon a condition where the malfeasance rating is categorized in a predetermined category. The alert signal may cause a notification to be displayed at the endpoint device. The notification may include one or more of: data stream details, including the account identifier of the user interacting with the entity, the malfeasance rating of the data stream, the malfeasance rating category of the data stream, the resource transfer metrics (e.g., the resource transfer volume and geolocation), a generative AI-prepared summary of the text data (as prepared by a generative AI model 310), a geolocation of the origination of the data stream, the timespan during which the data stream was transmitted, the type of device that transmitted the data stream, and so forth. The notification may take the form of a pop-up notification, email, SMS message, phone call, or the like.

Such alert signal may be transmitted when the malfeasance rating of the data stream is categorized in a predetermined category, such as “high”, “low”, and so forth. Additionally, or alternatively, the alert signal may be transmitted when the malfeasance rating of the data stream, if numerical, is above or below a predetermined threshold.

Next, at block 424, the alert signal may include code further causing the apparatus to reverse any resource transfer associated with the account identifier occurring during the data stream. This reversing of the resource transfer may mean that any monetary resources or other data that took place as a result of actions undertaken by the entity or the user during the data stream, may be returned to its original location prior to the beginning of the data stream. In some implementations, the code in the alert signal may be executed automatically upon creation of the alert signal, or upon receipt of the alert signal by the endpoint device. Alternatively, the alert signal may include code to cause to display, within or alongside the notification, a user interface interaction element for receiving a click, gesture, swipe, or the like, to positively affirm or decline the reversal of the resource transfer(s) associated with the account identifier. In this way, a security professional or automation engine may be provided with details (via the notification) of the allegedly malfeasant data stream and decide whether or not these details warrant the reversal of the resource transfer.

In some implementations, the process may continue at block 426, where the data stream is terminated. This termination of the data stream may be as a result of the alert signal automatically executing further code to terminate the data stream (i.e., hang up with the caller, end the chat session, and so forth). Similar to the above in block 424, the code in the alert signal to terminate the data stream may be executed automatically upon creation of the alert signal, or upon receipt of the alert signal by the endpoint device. Alternatively, the alert signal may include code to cause to display, within or alongside the notification, a user interface interaction element for receiving a click, gesture, swipe, or the like, to positively affirm or decline the termination of the data stream. In this way, a security professional or automation engine may be provided with details (via the notification) of the allegedly malfeasant data stream and decide whether or not to terminate the data stream.

As previously described, a notification having interaction elements (e.g., an element to affirm or decline the reversal of resource transfer, or an element to affirm or decline the termination of the data stream) may be caused by the system 130 to be displayed on an endpoint device. Interacting with such interaction elements may occur manually (e.g., by a security professional using a judgment call) or automatically (e.g., interaction elements being affirmed or declined by an automation engine depending on the time of day or day of the week that the notification is received at the endpoint device through, specific geographic regions identified as low trustworthiness, etc.). The system 130 may use these disposition actions (e.g., an affirmation or declining) and store the disposition action in a training data database alongside at least one of the corresponding text data, account data, adversarial action framework data, and/or historical malfeasance incident data. In this way, the machine learning model 232 may utilize such data (e.g., via unsupervised or supervised learning) to iteratively improve the calculation of the malfeasant rating.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for scalable AI-driven malfeasance detection with integrated feedback, the system comprising:
a processing device; and
a non-transitory storage device containing instructions, when executed by the processing device, the instructions cause the processing device to perform the steps of:
receiving a data stream comprising audio input data associated with a digital signal transmission, wherein the audio input data comprises speech data;
transmitting the speech data to a generative AI model;
generating, using natural language processing of the generative AI model, a document comprising text data based on the speech data;
determining, via a machine learning model, an account identifier based on the text data being provided to the machine learning model, and a malfeasance category corresponding to the account identifier;
determining, via the machine learning model based on the text data being provided to the machine learning model, resource transfer metrics comprising a location of the digital signal transmission and a resource transfer volume; and
determining, via the machine learning model, a malfeasance rating, wherein the malfeasance rating is categorized in a malfeasance rating category as high, medium, or low based on comparing the malfeasance rating to a predetermined threshold.

2. The system of claim 1, wherein the instructions further cause the processing device to perform the steps of:
retrieving account data comprising resource transfer occurrence patterns corresponding to the account identifier;
retrieving historical malfeasance incident data from a malfeasance incident database;
retrieving adversarial action framework data from an adversarial action framework database; and
training the machine learning model to determine the malfeasance rating of the text data using the account data, the historical malfeasance incident data, and the adversarial action framework data.

3. The system of claim 1, wherein generating the text data occurs in real time upon receiving the audio input data in a stream of audio input data, and wherein determining the malfeasance rating via the machine learning model occurs in parallel with generating the text data.

4. The system of claim 1, the instructions further cause the processing device to perform the steps of:
transmitting, upon a condition where the malfeasance rating is categorized in a predetermined category, an alert signal.

5. The system of claim 4, wherein the alert signal is transmitted to an endpoint device, and wherein the alert signal causes the endpoint device to display at least one of: (i) the account identifier, (ii) the malfeasance rating, (iii) the malfeasance rating category, and (iv) the resource transfer metrics.

6. The system of claim 4, wherein the alert signal comprises instructions to cause the processing device to perform the steps of:
reversing any resource transfer associated with the account identifier occurring during the data stream; and
terminating the data stream.

7. The system of claim 2, wherein the adversarial action framework database comprises an application programming interface (API) for access to a matrix comprising known adversary tactics and sequences of the adversary tactics.

8. A computer program product for scalable AI-driven malfeasance detection with integrated feedback, the computer program product comprising a non-transitory computer-readable medium comprising code causing an apparatus to:
receive a data stream comprising audio input data associated with a digital signal transmission, wherein the audio input data comprises speech data;
transmit the speech data to a generative AI model;
generate, using natural language processing of the generative AI model, a document comprising text data based on the speech data;
determine, via a machine learning model, an account identifier based on the text data being provided to the machine learning model, and a malfeasance category corresponding to the account identifier;
determine, via the machine learning model based on the text data being provided to the machine learning model, resource transfer metrics comprising a location of the digital signal transmission and a resource transfer volume; and
determine, via the machine learning model, a malfeasance rating, wherein the malfeasance rating is categorized in a malfeasance rating category as high, medium, or low based on comparing the malfeasance rating to a predetermined threshold.

9. The computer program product of claim 8, wherein the code further causes the apparatus to:
retrieve account data comprising resource transfer occurrence patterns corresponding to the account identifier;
retrieve historical malfeasance incident data from a malfeasance incident database;
retrieve adversarial action framework data from an adversarial action framework database; and
train the machine learning model to determine the malfeasance rating of the text data using the account data, the historical malfeasance incident data, and the adversarial action framework data.

10. The computer program product of claim 8, wherein generating the text data occurs in real time upon receiving the audio input data in a stream of audio input data, and wherein determining the malfeasance rating via the machine learning model occurs in parallel with generating the text data.

11. The computer program product of claim 8, wherein the code further causes the apparatus to:
transmit, upon a condition where the malfeasance rating is categorized in a predetermined category, an alert signal.

12. The computer program product of claim 11, wherein the alert signal is transmitted to an endpoint device, and wherein the alert signal causes the endpoint device to display at least one of: (i) the account identifier, (ii) the malfeasance rating, (iii) the malfeasance rating category, and (iv) the resource transfer metrics.

13. The computer program product of claim 11, wherein the alert signal comprises code further causing the apparatus to:
reverse any resource transfer associated with the account identifier occurring during the data stream; and
terminate the data stream.

14. The computer program product of claim 9, wherein the adversarial action framework database comprises an application programming interface (API) for access to a matrix comprising known adversary tactics and sequences of the adversary tactics.

15. A method for scalable AI-driven malfeasance detection with integrated feedback, the method comprising:
receiving a data stream comprising audio input data associated with a digital signal transmission, wherein the audio input data comprises speech data;
transmitting the speech data to a generative AI model;
generating, using natural language processing of the generative AI model, a document comprising text data based on the speech data;
determining, via a machine learning model, an account identifier based on the text data being provided to the machine learning model, and a malfeasance category corresponding to the account identifier;
determining, via the machine learning model based on the text data being provided to the machine learning model, resource transfer metrics comprising a location of the digital signal transmission and a resource transfer volume; and
determining, via the machine learning model, a malfeasance rating, wherein the malfeasance rating is categorized in a malfeasance rating category as high, medium, or low based on comparing the malfeasance rating to a predetermined threshold.

16. The method of claim 15, wherein the method further comprises:
retrieving account data comprising resource transfer occurrence patterns corresponding to the account identifier;
retrieving historical malfeasance incident data from a malfeasance incident database;
retrieving adversarial action framework data from an adversarial action framework database; and
training the machine learning model to determine the malfeasance rating of the text data using the account data, the historical malfeasance incident data, and the adversarial action framework data.

17. The method of claim 15, wherein generating the text data occurs in real time upon receiving the audio input data in a stream of audio input data, and wherein determining the malfeasance rating via the machine learning model occurs in parallel with generating the text data.

18. The method of claim 15, wherein the method further comprises:
transmitting, upon a condition where the malfeasance rating is categorized in a predetermined category, an alert signal.

19. The method of claim 18, wherein the alert signal is transmitted to an endpoint device, and wherein the alert signal causes the endpoint device to display at least one of: (i) the account identifier, (ii) the malfeasance rating, (iii) the malfeasance rating category, and (iv) the resource transfer metrics.

20. The method of claim 16, wherein the adversarial action framework database comprises an application programming interface (API) for access to a matrix comprising known adversary tactics and sequences of the adversary tactics.
